(19) United States
(12) Patent Application Publication
(10) Pub. No.: US 2024/0149795 A1
(43) Pub. Date: May 9, 2024

(54) INTERCHANGEABLE MEMBER FOR A VEHICLE

(71) Applicant: Rivian IP Holdings, LLC, Plymouth, MI (US)

(72) Inventor: Jonathan David SALERNO, Newport Beach, CA (US)

(21) Appl. No.: 18/053,213

(22) Filed: Nov. 7, 2022

(51) Int. Cl. B60R 9/10; B60R 9/12

(52) U.S. Cl. CPC B60R 9/10; B60R 9/12

(57) ABSTRACT

Disclosed are embodiments generally directed to a vehicle component, such as a tailgate or window sill, that includes an accessory locking mechanism to couple a corresponding locking mechanism of an interchangeable member. The interchangeable member is a modular accessory coupled to the vehicle component. The interchangeable member is one interchangeable member of a plurality of interchangeable members that are similarly coupled to the vehicle component. Example interchangeable members include a bike interface to secure a bike to the vehicle, a ski interface to secure skis to the vehicle, or a clamping interface having a plurality of clamps having an adjustable height to secure substantially planar components, such as pieces of wood, to the vehicle. By employing these embodiment, a vehicle can be selectively equipped with at least one interchangeable member, thereby expanding the convenience and utility that the vehicle delivers.

### INTRODUCTION

A vehicle is a wheeled, transportation device that facilitates various transportation tasks, such as comfortably seating people, providing storage, and achieving speeds that people are generally unable to achieve on foot. In the context of a truck, a truck bed provides additional space for storage.

### SUMMARY

Various aspects of the technology described herein are generally directed to, among other things, a vehicle component, such as a tailgate or window sill, that includes an accessory locking mechanism to couple a corresponding locking mechanism of an interchangeable member. The tailgate is the board or gate at the rear of the vehicle and above the chassis of the vehicle. The tailgate can be removed or hinge to transition between a closed position and an opened position, for example, to provide access to a truck bed of the vehicle. The truck bed is the area rearward the vehicle cab and above the chassis, often used to enclose vehicle cargo, and that is closed off by the tailgate. The window sill is the lower part of the window and includes a slit into which a window may slide in and out of, for example, to transition between a closed state and open state. Any number of windows, such as the side window and the rear window may include the window sill. The interchangeable member is a modular accessory coupled to the vehicle component, such as a tailgate or a window sill. The interchangeable member is one interchangeable member of a plurality of interchangeable members that are similarly coupled to any vehicle components, such as the tailgate or window sill.

In the context of a tailgate, the interchangeable member is coupled to a top surface of the tailgate. The top surface of the tailgate is the portion of the tailgate that is most elevated from the ground when the tailgate is in the closed (e.g., upright) position. When the tailgate is in the closed position, the top surface is substantially parallel to the ground. The top surface of the tailgate includes the accessory locking mechanism that is engageable with a corresponding locking mechanism of the interchangeable member. For example, the accessory locking mechanism of the vehicle component includes an opening that receives a clip of the locking mechanism of the interchangeable mechanism. Example interchangeable members include a bike interface to secure a bike to the vehicle, a ski interface to secure skis to the vehicle, or a clamping interface having a plurality of clamps having an adjustable height to secure substantially planar components, such as pieces of wood, to the vehicle. The locking mechanism of each of the interchangeable members may be the same so that the interchangeable members may be coupled to the accessory locking mechanism and be changed out for other interchangeable members.

By way of examples, in one embodiment, an apparatus includes a locking mechanism of a tailgate configured to lock an interchangeable member to the tailgate. Additionally, the locking mechanism is configured to unlock the interchangeable member from the tailgate.

In another embodiment, a vehicle includes a body and a vehicle component coupled to the body. The vehicle component includes a locking mechanism to selectively lock to an interchangeable member.

In yet another embodiment, a method is provided. The method includes coupling an interchangeable member to a locking mechanism configured to uncouple the interchangeable member from the tailgate.

In this manner, the vehicle component, such as tailgate, and interchangeable members provide additional functionality other than merely closing off and providing access to the truck bed. In particular, by employing aspects of the disclosed subject matter, the tailgate provides a customizable and modular system to couple a variety of interchangeable members to equip the vehicle with additional functionality, thereby expanding the utility and variety of utility that the vehicle delivers. The relatively compact size of certain interchangeable members improves storage and quick attachment to the tailgate. For example, the interchangeable members can be stored under the vehicle seats, inside a gear tunnel, or in a trunk, and retrieved to be coupled to the vehicle component, such as the tailgate. Although this summary discussed in the context of a tailgate, it should be understood that the interchangeable members may couple to any other or additional vehicle components, such as the window sill, the perimeter of the truck bed, the vehicle roof, and/or any other vehicle component having the accessory locking mechanism.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a schematic diagram of an example schematic of a vehicle that includes a tailgate, in accordance with aspects of the technology described herein;

FIG. 2 is a schematic diagram of an example vehicle having an interchangeable member, comprising a tailgate cover, coupled to a tailgate of the vehicle, in accordance with aspects of the technology described herein;

FIG. 3 is a schematic diagram of an example vehicle having an interchangeable member, comprising a tailgate cover, coupled to a tailgate of the vehicle, in accordance with aspects of the technology described herein;

FIG. 4A is a schematic diagram of an exploded view of an example vehicle having an interchangeable member, comprising a bike interface, coupled to a tailgate of the vehicle, in accordance with aspects of the technology described herein;

FIG. 4B is a schematic diagram of an example vehicle having an interchangeable member, comprising a bike interface, coupled to a tailgate of the vehicle, in accordance with aspects of the technology described herein;

FIG. 5A is a schematic diagram of an exploded view of an example vehicle having an interchangeable member, comprising a ski interface, coupled to a tailgate of the vehicle, in accordance with aspects of the technology described herein;

FIG. 5B is a schematic diagram of an example vehicle having an interchangeable member, comprising a ski interface, coupled to a tailgate of the vehicle, in accordance with aspects of the technology described herein;

FIG. 6A is a schematic diagram of an exploded view of an example vehicle having an interchangeable member, comprising a clamping interface, coupled to a tailgate of the vehicle, in accordance with aspects of the technology described herein;

FIG. 6B is a schematic diagram of an example vehicle having an interchangeable member, comprising a clamping interface, coupled to a tailgate of the vehicle, in accordance with aspects of the technology described herein;

FIG. 7A is a schematic diagram of an example vehicle having an interchangeable member of a plurality of interchangeable members coupled to a window sill of the vehicle, in accordance with aspects of the technology described herein;

FIG. 7B is a schematic diagram of an example vehicle having an interchangeable member of a plurality of interchangeable members coupled to a rear cargo guard of the vehicle, in accordance with aspects of the technology described herein;

FIG. 8 is a flow diagram of an example method for providing an interchangeable member to a vehicle, in accordance with aspects of the technology described herein; and

FIG. 9 is a schematic diagram of an example electric vehicle system, in accordance with aspects of the technology described herein.

### DETAILED DESCRIPTION OF THE DISCLOSED SUBJECT MATTER

Vehicle drivers rely on vehicles to provide transportation. To provide transportation-related functionality, vehicles typically include any number of dedicated storage spaces, such as under the hood, under or on top the vehicle seats, within the body of the vehicle, inside a glove compartment, and so forth. For example, a car may include a storage space, such as a trunk; and a truck may include a storage space, such as a truck bed. These storage spaces may serve as dedicated regions for storing items without compromising the space or comfort of the driver and passengers. The storage compartment may transport any number of items, such as travel luggage, tools, and a tire, to name a few.

In the context of trucks, a tailgate is positioned at a rear side of a vehicle. The tailgate is generally limited to providing access to the bed of the vehicle by hinging from an upright, closed position to a downward, open position. Certain vehicles are not configured with infrastructure to empower drivers or other personnel with additional tailgate functionality that is customizable, modular, and easy to couple to the tailgate. Although a driver may utilize a rope to secure vehicle cargo to the truck bed or the tailgate, the rope may require user knowledge of particular knots to avoid the rope coming undone; may require extensive user time and effort to tie the knot or untie the knot; may be difficult to store because of the expansive shape of untied ropes; and may only fix cargo along certain axes or planes, such that the cargo may still translate along or rotate about undesirable directions. A more convenient attachment includes a VELCRO® strap because it takes less time to pull or attach cargo having VELCRO®, but such a strap may fail to deliver the requisite mechanism for securing larger or heavier cargo, such as bikes, skis, and/or wood. Indeed, the adhesive of the VELCRO® strap may not be tailored to securing larger vehicle cargo.

Accordingly, providing improvements to tailgates for vehicles, the improvements which are difficult to achieve, can address the limitations described above. As such, a more comprehensive vehicle management system, with an alternative basis for providing a customizable approach to enhancing and diversifying the functionality provided by tailgates, can improve securing and/or transportation of items transported by the vehicle in vehicle management systems.

With this in mind, various aspects of the technology described herein are generally directed to systems and methods for, among other things, a vehicle component, such as a tailgate or window sill, that includes an accessory locking mechanism to couple a corresponding locking mechanism of an interchangeable member. In one example, “couple” or “lock” broadly refers to the process of combining or affixing components to each other. In one example, after components are locked or coupled, the lock or coupling relationship may be selectively released so that the components become decoupled or unlocked and movable with respect to each other. In this manner, certain components discussed herein are selectively coupled to each other. However, it should be understood that “couple,” and “lock,” as used herein, are not intended to limit the types of mechanisms or processes used to achieve a target fixture between two components.

In one embodiment, the tailgate is the board or gate at the rear of the vehicle and above the chassis of the vehicle. The tailgate can be removed or hinge down to transition between a closed position and an opened position, for example, to provide access to a truck bed of the vehicle. In one embodiment, the truck bed is the area rearward the vehicle cab and above the chassis, often used to transport vehicle cargo, and that is closed off by the tailgate. In one embodiment, the window sill is the lower part of the window and includes a slit into which a window may slide in and out of, for example, to transition between a closed state and open state. Any number of windows, such as the side window(s) and the rear window(s) may include the window sill. In one embodiment, the interchangeable member is a modular accessory configured to couple to the vehicle component, such as a tailgate or a window sill. In one embodiment, the interchangeable member is one interchangeable member of a plurality of interchangeable members that are similarly connectable to any suitable vehicle component, such as the tailgate or window sill.

In the context of a tailgate, the interchangeable member may be coupled to any surface, such as the top surface, of the tailgate. In one embodiment, the top surface of the tailgate is the portion of the tailgate that is most elevated from the ground when the tailgate is in the upright (e.g., closed) position. When the tailgate is in the upright position, in one example, the top surface is substantially parallel to the ground. The top surface of the tailgate may include the accessory locking mechanism that is engageable with a corresponding locking mechanism of the interchangeable member. For example, the accessory locking mechanism includes an opening that receives a locking clip of the locking mechanism of the interchangeable mechanism. Example interchangeable members include a bike interface to secure a bike to the vehicle, a ski interface to secure skis to the vehicle, a fishing rod interface, or a plurality of clamps having an adjustable height to secure substantially planar objects, such as pieces of wood, to the vehicle, among other interchangeable members. The locking mechanism of each of the interchangeable members may be the same so that the interchangeable members may be coupled to the accessory locking mechanism and be changed out for other interchangeable members via a similar locking mechanism.

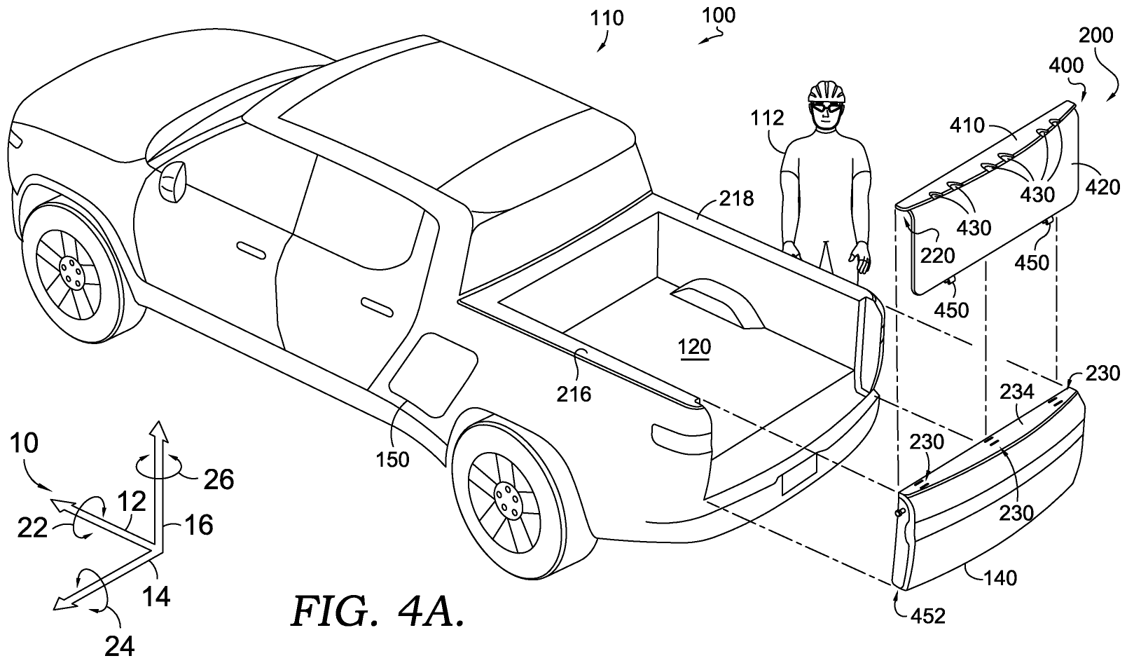

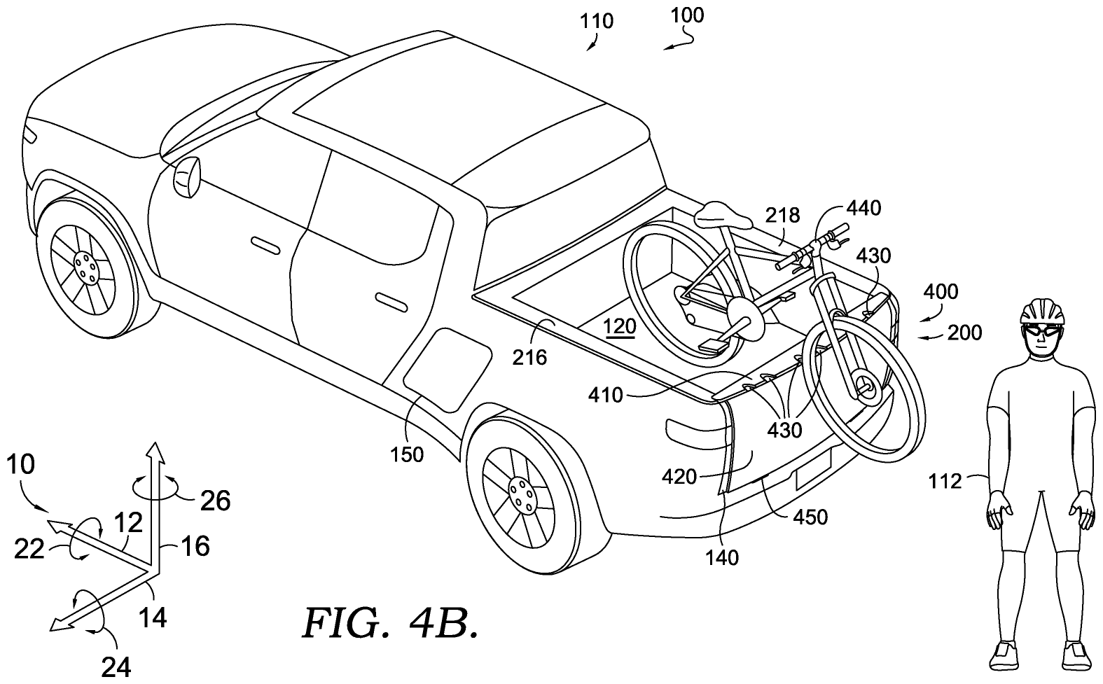

With respect to one example interchangeable member, the bike interface includes a base, a first side panel, and/or a second side panel. The underside of the base may include a locking mechanism that is engageable with the accessory locking mechanism on any suitable vehicle component, such as the top surface of the tailgate (or the top surface around the perimeter of the truck bed). In this manner, the bike interface may become fixed to the tailgate (or the top surface around the perimeter of the truck bed). The first side panel and/or the second side panel may drape over the outside and inside of the tailgate, respectively. In this manner, the first and second side panels of the bike interface may serve as a layer between the bike and the tailgate, thereby protecting the tailgate from a bike directly contacting the tailgate. To further prevent the bike from sliding along the tailgate, in one example, the bike interface includes any number of notches on the base, the first side panel, and/or the second side panel. The notches may be of a width equal to or greater to a width of the bike tire or a bike axel so that the bike may rest on the notches and not slide along the tailgate. An example bike interface is illustrated in FIGS. 4A and 4B.

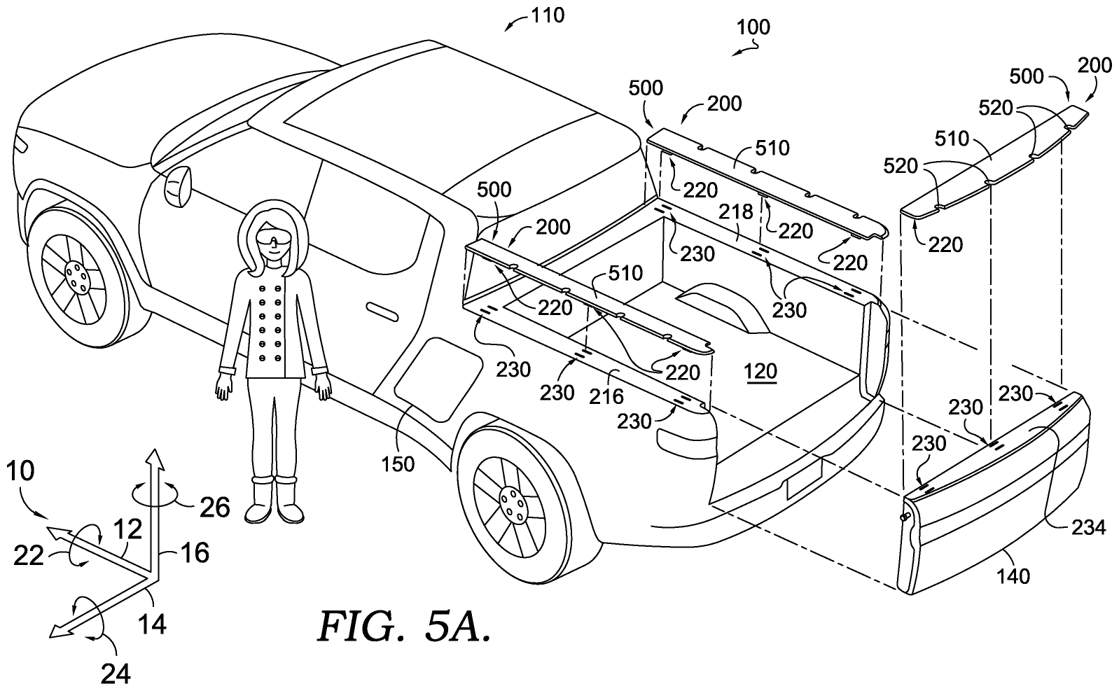

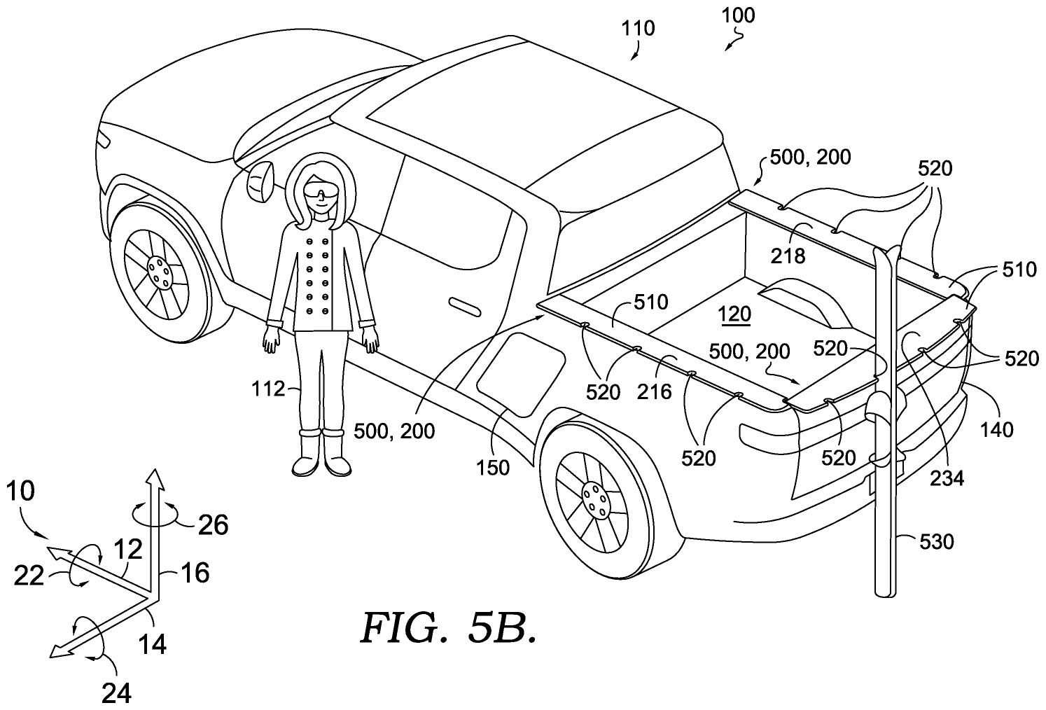

With respect to another example of an interchangeable member, the ski interface may be coupled to any suitable vehicle component, such as the tailgate, to allow for efficient storage and securing of skis. In one example, the ski interface includes a locking mechanism on the underside. The locking mechanism of the ski interface may be engageable with the accessory locking mechanism on the top surface of the tailgate (or the top surface around the perimeter of the truck bed) to become fixed to the tailgate (or the top surface around the perimeter of the truck bed). In one example, the ski interface includes one or more notches to receive one or more skis to secure the skis to the tailgate. The notches of the ski interface receive a pair of skis for temporary storage, for example, while a driver puts on their ski boots. In this manner, the skis may be secured to the vehicle without leaning against the vehicle at an angle that would cause the skis to slide off the vehicle, thereby undesirably contacting the body of the vehicle or causing the skis to fall. An example ski interface is illustrated in FIGS. 5A and 5B.

With respect to another example of an interchangeable member, the clamping interface may be coupled to the tailgate and allows for efficient storage and transportation of substantially planar vehicle cargo, such as lumber. In one example, the clamping interface includes a locking mechanism on the underside. The locking mechanism of the clamping interface may be engageable with the accessory locking mechanism on any vehicle component, such as the top surface of the tailgate (or the top surface around the perimeter of the truck bed). In this manner, the clamping interface may become fixed to any vehicle component, such as the tailgate (or the top surface around the perimeter of the truck bed). In one example, the clamping interface includes one or more clamps that are extendable out of the clamping interface to a plurality of heights and that are retractable into the clamping interface. To facilitate changing the height of the clamps, the clamping interface may include a ratcheting mechanism that is engageable to adjust a height of the at least one clamp between a recessed position coplanar with the base on the clamping interface and an extended position raised relative to the base of the clamping interface to a maximum height.

In this manner, the tailgate and interchangeable members provide additional functionality other than merely closing off and providing access to the truck bed. In particular, the tailgate provides a customizable and modular system to selectively couple a variety of interchangeable members to equip the vehicle with additional functionality, thereby expanding the utility and variety of functionality that the tailgate delivers. The relatively compact size of certain interchangeable members improves quick attachment to the tailgate and storage. For example, the interchangeable members can be stored under the vehicle seats, in a gear tunnel, or truck, and retrieved to be coupled to the tailgate.

Although embodiments of the disclosure are discussed in the context of a tailgate, it should be understood that the interchangeable members may couple to any other or additional vehicle components, such as the window sill, the perimeter of the truck bed, the vehicle roof, and/or any other vehicle component having the accessory locking mechanism. Moreover, although only certain interchangeable members are discussed in detail herein, it should be understood that the interchangeable members may also include any other suitable interchangeable member, such as a fishing interface for coupling fishing rods and equipment to the vehicle, a skateboard interface for coupling a skateboard or longboard to the vehicle, a toolbox interface for coupling a toolbox to the vehicle, a basket interface for coupling an additional storage compartment to the vehicle, and so forth.

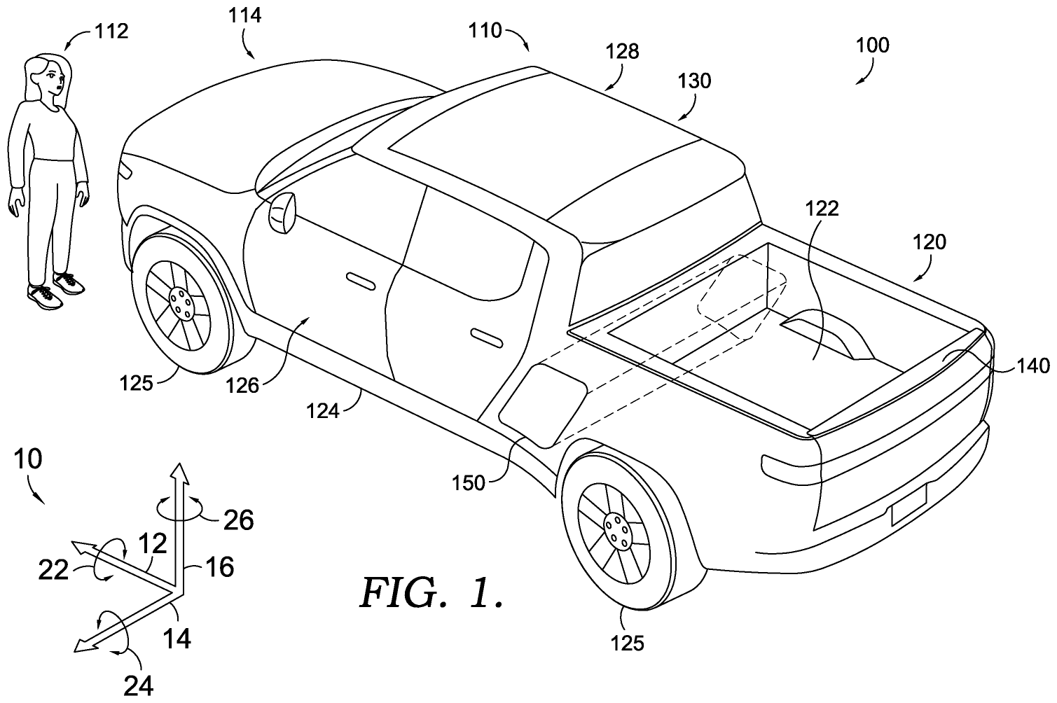

Aspects of the technical solution can be described by way of examples and with reference to FIGS. 1-9. As a preliminary matter, certain embodiments disclosed herein are discussed within the context of coordinate system 10. As illustrated, the coordinate system 10 includes three orthogonal axes. As illustrated, the example coordinate system 10 includes a longitudinal axis 12, a lateral axis 14, and a vertical axis 16. Additionally, in the context of rotational motion, the coordinate system 10 defines a roll direction 22 as rotation about the longitudinal axis 12, a pitch direction 24 as rotation about the lateral axis 14, and yaw direction 26 as rotation about the vertical axis 16. Within the context of the illustrated vehicle management system 100, the longitudinal axis 12 may be oriented along a direction of travel of a vehicle 110. The lateral axis 14 may be oriented perpendicular to the direction of travel of the vehicle 110 and parallel to a ground on which the vehicle 110 travels. The vertical axis 16 may be oriented along the same direction as the gravity vector.

With this in mind, FIG. 1 illustrates a vehicle management system 100 that includes a vehicle management client 112 and the vehicle 110. Any of the embodiments disclosed herein, including those in FIGS. 1-9 may operate within the vehicle management system 100, as illustrated. As used herein, “vehicle management client” 112 may refer to a personnel or user who engages with the vehicle 110 and/or the corresponding components. Examples of the vehicle management client 112 include a driver of the vehicle 110, a passenger of the vehicle 110, a station manager of a charging station or fuel pump station, a service personnel, maintenance personnel, and any other person that may interact with the vehicle 110. The vehicle management client 112 may operate any of the vehicles 110 described with respect to or illustrated in FIGS. 1-9. Moreover, although certain embodiments discussed herein are discussed in the context of a vehicle 110 that is an electric vehicle (EV), it should be understood that aspects of the embodiments disclosed herein apply to a hybrid vehicle, a vehicle powered by fuel, or any other vessel capable of transporting passengers and/or cargo.

In one embodiment, the vehicle 110 includes a body 114. In one example, the body 114 of the vehicle includes externally facing features of the vehicle, as well as internal features of the vehicle. Example vehicle components of the body 114 of the vehicle 110 include a tailgate, a truck bed, a perimeter of the truck bed, a window sill, a vehicle roof, sides of the vehicle, the underside of the chassis of the vehicle, the rear cargo guard of the vehicle, and/or any other vehicle components discussed herein, as well as others.

The vehicle 110 may include a storage space, such as the truck bed 120. Along the vertical axis 16, the truck bed 120 may be defined as having a floor bed 122 supported by the vehicle chassis 124 and as having an exposed top. The chassis 124 is the supporting frame of a vehicle and may sit on top of the tires 125 and corresponding suspension system. Although the illustrated vehicle has a truck bed 120 with an exposed top, in some embodiments, a removable or permanent cover is positioned on the top of the truck bed 120, for example, to protect vehicle cargo from weather, such as rain, snow, and so forth. The truck bed 120 is in the rear storage portion of the vehicle 110. Along the illustrated lateral axis 14, the truck bed 120 is defined by a left side 126 (e.g., driver side) and a right side 128 (e.g., passenger side) of the vehicle 110. Along the illustrated longitudinal axis 12, the truck bed 120 is defined in front by the rear side of the cabin 130 and may be defined in the rear side by the tailgate 140. The cabin 130 is the compartment of the vehicle 110 that houses the vehicle management client 112, and in one example, is defined between the dashboard and the back seat of the vehicle 110.

To provide additional storage space, in one embodiment, the vehicle 110 includes a gear tunnel 150. The gear tunnel 150 is an opening extending between the left side 126 of the vehicle 110 and the right side 128 of the vehicle 110, which may be accessed by opening corresponding gear tunnel doors on either side of the vehicle, for example. The gear tunnel 150 may extend through the body of the vehicle from a gear tunnel door on the left side 126 to a gear tunnel door on the right side 128 of the vehicle 110. More specifically, the gear tunnel 150 may extend from the left side 126 and the right side 128 of the vehicle 110 along the lateral axis 14 that is substantially perpendicular to a direction of travel of the vehicle 110. An example gear tunnel 150 is that included in the RIVIAN® RIT model. In one example, the interchangeable members disclosed herein may have a length less than or equal to the length of the gear tunnel 150 (e.g., the gear tunnel 150 extending bet the left side 126 and the right side 128). In this manner, the interchangeable members nay be stored in the gear tunnel 150 for easy retrieval and customization of the vehicle 110.

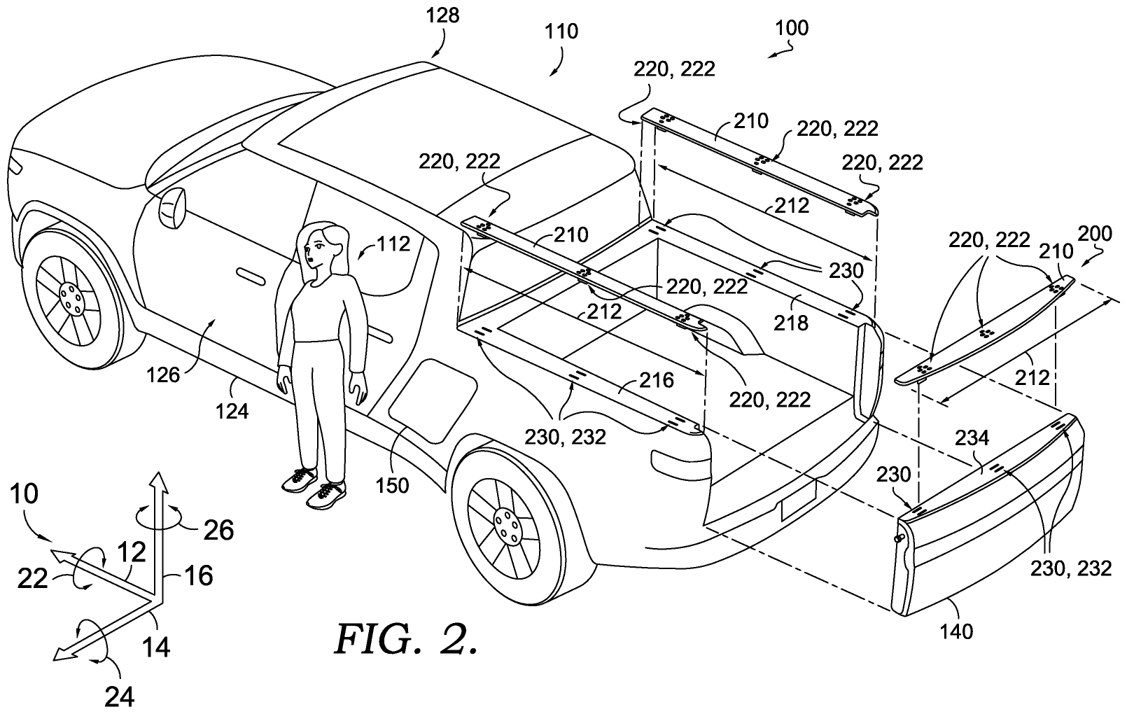

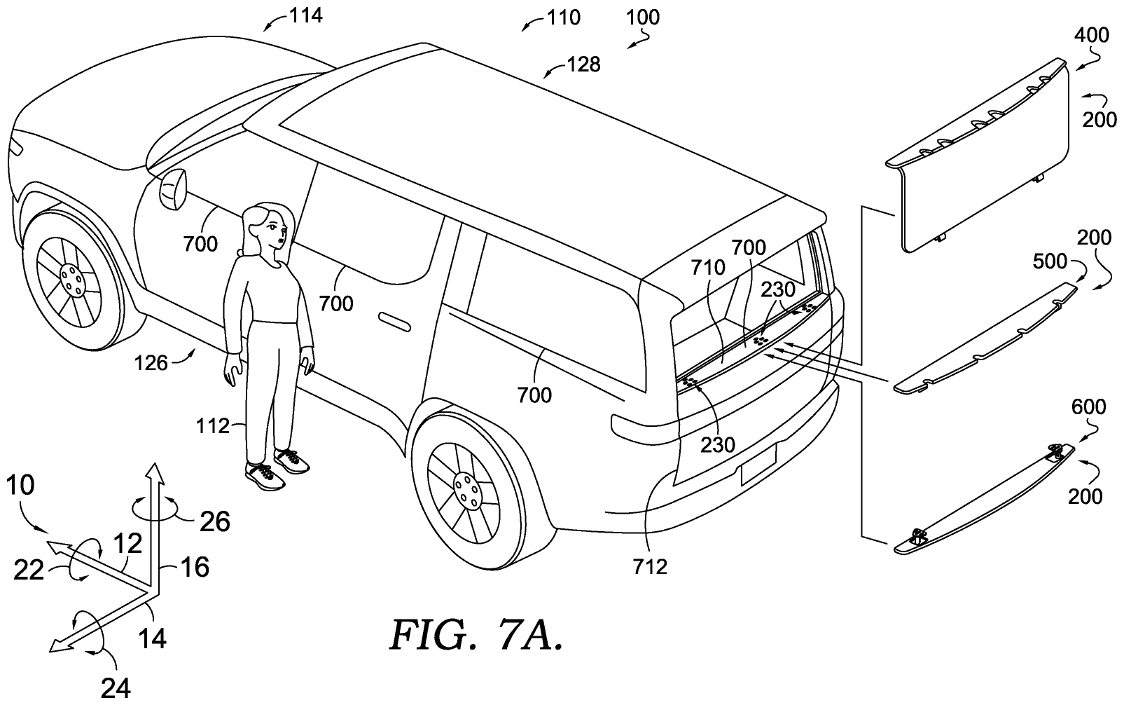

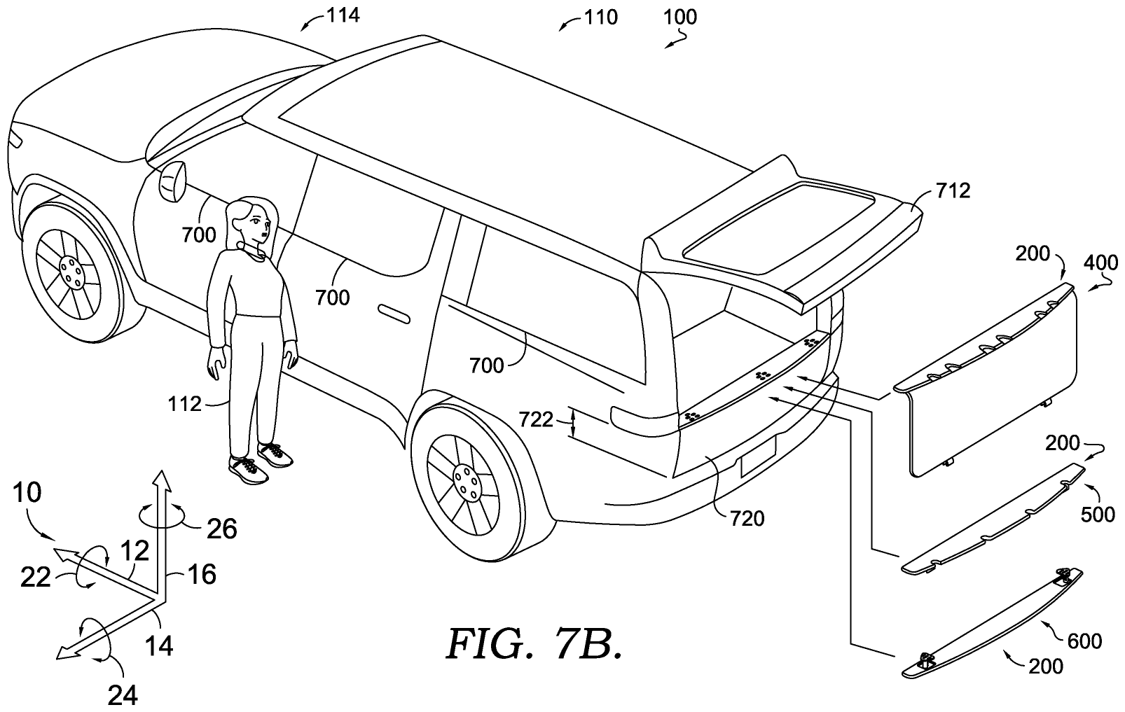

Turning to FIG. 2, illustrated is an example vehicle 110 having an interchangeable member 200, comprising a tailgate cover 210, coupled to a tailgate 140 of the vehicle 110, in accordance with aspects of the technology described herein. As discussed herein, the interchangeable member 200 is a modular accessory coupled to the vehicle component, such as the tailgate 140 (or the perimeter of the truck bed or a window sill, as illustrated in FIGS. 7A and 7B). The interchangeable member 200 may be one interchangeable member of a plurality of interchangeable members that are similarly coupled to a vehicle component.

The interchangeable member 200 may be coupled to the vehicle 110 between the body in white (BiW) and trim of the vehicle component (e.g., the tailgate 140). The BiW refers to a vehicle's frame when all its components have been joined (e.g., welded) together (in some instance, except the moving parts (e.g., hoods, fenders, and the like), trims (e.g., glass, seats, and the like), and/or chassis subassemblies). In one example, BiW constitutes less than half of the vehicle's curb weight. BiW can be made into two structures: (1) the structure where all body members are carrying load with chassis 124 in-built with BiW and are integrated with each other, and (2) the body-on-frame structure where the frame is the main load-carrying member. In one example, the trim refers to the details of the vehicle 110 that collectively differentiate between vehicle models, and such details may include the types of seats, the type of glass, the body contour, and the like. Although the interchangeable member 200 is discussed as being applied to the vehicle between the BiW and the trim, it should be understood that the interchangeable member 200 may be applied to the vehicle 110 via any stage of the manufacturing process.

The interchangeable member 200 may have a length 212 that is less than or substantially equal to a length of the gear tunnel 150 (FIG. 1) for easy storage in the gear tunnel 150. In one example, the length 212 of the interchangeable member 200 is less than the length between the left side 126 and the right side 128 of the vehicle 110. In one embodiment, the length 212 of the interchangeable member 200 is substantially equal to the distance between left truck bed edge 216 on the left side 126 of the vehicle 110 and the right truck bed edge 218 on the right side 128 of the vehicle 110.

In some embodiments, the interchangeable member 200 includes a locking mechanism 220 that is engageable with an accessory locking mechanism 230 of the vehicle 110. In the illustrated embodiment, the locking mechanism 220 includes pins 222 and the accessory locking mechanism 230 includes openings 232 that receive the pins 222 to couple the interchangeable member 200 to the tailgate 140. In the illustrated embodiment, the accessory locking mechanism 230 is positioned on a top surface 234 of the tailgate 140. The top surface 234 of the tailgate 140 is the portion of the tailgate 140 that is most elevated from the ground when the tailgate 140 is in the upright (e.g., closed) position. When the tailgate 140 is in the upright position, the top surface 234 is substantially parallel to the ground. In one embodiment, the accessory locking mechanism 230 includes openings 232 that may receive a pin 222 of the locking mechanism 220 of the interchangeable member. Example pins 222 of the locking mechanism 220 include spring clips, paddle flaps, cotter pins, clevis pins, taper pins, split pins, “R” clips (e.g., hitch pin), circlips, roll pins, linch pins, or any other suitable fasteners, clips, and/or mechanical pins. When the pins 222 of the locking mechanism 220 engage with the openings 232 of the accessory locking mechanism 230, the interchangeable member 200 couples to the tailgate 140, as illustrated. Although in the illustrated embodiment the accessory locking mechanism 230 includes three pairs of (e.g., total of six) openings 232 that receive corresponding locking mechanisms 220 of the interchangeable member 200, it should be understood that the accessory locking mechanism 230 and the locking mechanism 220 may include any other number of openings 232 and pins 222, respectively.

To couple the interchangeable member 200 to the tailgate 140, a force may be applied to engage the locking mechanism 220 to the accessory locking mechanism 230 of the tailgate 140. For example, a downward force (e.g., orthogonal to the top surface 234 of the tailgate 140) applied to the interchangeable member 200 along the vertical axis 16 causes the pins 222 of the locking mechanism 220 to “snap on” to the accessory locking mechanism 230. To remove the interchangeable member 200 from the tailgate 140, a force may be applied to pull the interchangeable member 200 off of the tailgate 140. For example, a force pulling the interchangeable member 200 upward from (e.g., orthogonal to) the top surface 234 of the tailgate 140 causes the locking mechanism 220 of the interchangeable member 200 to decouple from the tailgate.

In one embodiment, the tailgate cover 210 is applied to the vehicle 110 between the BiW and the trim. The tailgate cover 210 may correspond to the default interchangeable member 200. For example, the tailgate 140 may be manufactured to include the tailgate cover 210 as the default interchangeable member 200. The tailgate cover 210 may serve as a layer of protection between the external environment and the accessory locking mechanism 230. In this manner, the tailgate cover 210 may block debris from entering the accessory locking mechanism 230. When the vehicle management client 112 wants to replace the tailgate cover 210 with another interchangeable member 200, the tailgate cover 210 may be removed by disengaging the locking mechanism via any of the techniques disclosed herein, among others.

Although certain embodiments are discussed as having the accessory locking mechanism 230 positioned on the top surface 234 of the tailgate 140, it should be understood that the accessory locking mechanism 230 may instead be positioned on any region of the vehicle 110. For example, as illustrated, the accessory locking mechanism 230 is positioned on the left truck bed edge 216 on the left side 126 of the vehicle 110, on the right truck bed edge 218 on the right side 128 of the vehicle, or both. In such embodiments, the interchangeable member 200, such as the illustrated tailgate cover, is coupled to any portion along the left truck bed edge 216 and/or any portion along the right truck bed edge 218, and the like.

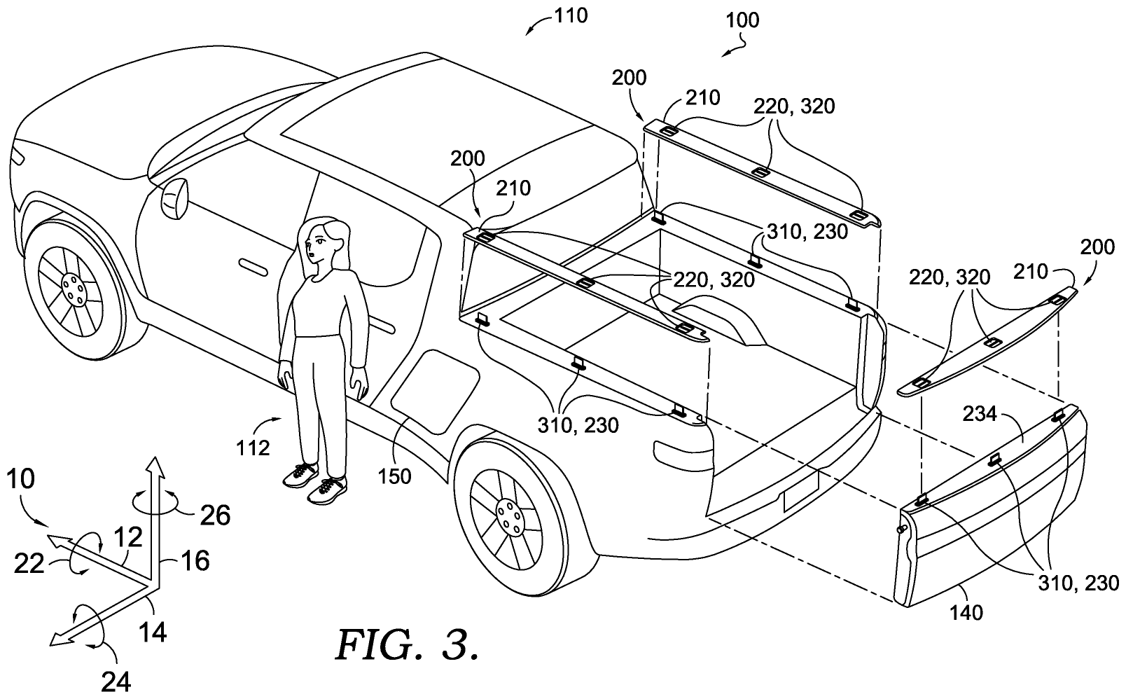

To provide another example of a locking mechanism 220, FIG. 3 depicts a schematic diagram of an example vehicle 110 having an interchangeable member 200 (FIG. 2), comprising a tailgate cover 210, coupled to a tailgate 140 of the vehicle 110, in accordance with aspects of the technology described herein. Whereas the embodiment illustrated in FIG. 2 includes the tailgate 140 having openings 232 as part of the accessory locking mechanism 230 and the interchangeable member having pins 222 as part of the locking mechanism 220, the embodiment illustrated in FIG. 3 includes the tailgate 140 having clips 310 as part of the accessory locking mechanism 230 and the interchangeable member 200 having openings 320 through which the clips 310 pass through. In one embodiment, the clips 310 extend outward from the top surface 234 of the tailgate 140. The openings 320 of the interchangeable member 200 may be sized to substantially match or be slightly larger than the cross section of the clips 310 to reduce the play or movement between the interchangeable member 200 and the tailgate 140. In one embodiment, the clips 310 include spring clips, paddle flaps, cotter pins, clevis pins, taper pins, split pins, “R” clips (e.g., hitch pin), circlips, roll pins, linch pins, or any other suitable fasteners, clips, and/or mechanical pins.

To lock the interchangeable member 200 to the tailgate 140, the clips 310 may rotate about 90 degrees from being upright to being downward and parallel with the top surface 234 after the clips 310 slide through the openings 320 of the interchangeable member 200 so that the interchangeable member 200 rests on the top surface 234 of the tailgate 140. For example, the clips 310 on the top surface 234 are rotatable about the lateral axis 14 in pitch direction 24 between the upward and downward positions. As another example, the clips 310 on the left truck bed edge 216 and the right truck bed edge 218 are rotatable about the longitudinal axis 12 in roll direction 22 between the upward and downward positions. To better accommodate the clips 310 when the clips 310 transition to being downward and parallel with the top surface 234, the region around the openings 320 of the interchangeable member 200 may be depressed relative to the surrounding height of the interchangeable member 200. To decouple the interchangeable member 200 from the tailgate 140, the clips 310 may rotate about 90 degrees from being downward to being upright and perpendicular with the top surface 234. When the clips 310 are upright and perpendicular with the top surface 234, the interchangeable member 200 may be lifted up and be decoupled from the tailgate 140.

Turning now to FIGS. 4A and 4B (collectively referred to as “FIG. 4”), which are discussed together, FIG. 4A depicts a schematic diagram of an exploded view of an example vehicle 110 having an interchangeable member 200, comprising a bike interface 400, coupled to a tailgate 140 of the vehicle 110, in accordance with aspects of the technology described herein. In contrast, FIG. 4B depicts the vehicle 110 of FIG. 4A in an assembled configuration, instead of in an exploded configuration. In some embodiments, the bike interface 400 is coupled to the tailgate 140 via corresponding locking mechanisms. For example, a locking mechanism 220 of the bike interface 400 engages with the accessory locking mechanism 230 of the tailgate 140 (or other vehicle components, such as the left truck bed edge 216 and the right truck bed edge 218).

In one embodiment, the bike interface 400 includes a base 410 parallel to the top surface 234 of the tailgate and a first side panel 420 substantially perpendicular to the top surface of the tailgate. The base 410 of the bike interface 400 may serve as a protective cover of a top surface 234 of the tailgate 140, or the left truck bed edge 216 or right truck bed edge 218 of the truck bed 120. For example, the base 410 covers the top surface 234 of the tailgate 140. The first side panel 420 of the bike interface 400 may serve as a protective cover for the externally facing face of the tailgate 140, as illustrated in FIG. 4B. As further illustrated, the base 410 and the first side panel 420 are rigidly fixed to one another, such that the base 410 and the first side panel 420 are not removable from each other. In this manner, the bike interface 400 can be one part. However, in one embodiment, the base 410 and the first side panel 420 are removable from one another, such that the base 410 and the first side panel 420 can be detached from each other to split the bike interface 400 into various parts.

In the illustrated embodiment, the base 410 and/or the first side panel 420 includes a plurality of notches 430. As illustrated in FIG. 4, the notches 430 may be sized to accommodate and receive a corresponding tire of a bike 440. The notches 430 may vary in size, such that the notches 430 may accommodate tires of various sizes. When a tire of a bike 440 is positioned within a notch 430, the notch 430 may restrict movement of the bike 440, for example, along the lateral axis 14. In one example, the bike interface 400 includes additional securing mechanisms, such as a strap, to further restrict movement of the bike 440. For example, a strap may be tied around the circumference of the tire of the bike to further secure the bike 440 to the notch 430 to prevent movement along the longitudinal axis 12, the lateral axis 14, or the vertical axis 16. In this manner, the bike interface 400 facilitates securing, storing, and transporting the bike.

Although the illustrated embodiment includes a bike interface 400 having notches 430 on the rear side of the tailgate 140, it should be understood that in some embodiments, the bike interface 400 alternatively or additionally includes one or more notches on the inside of the tailgate 140. For example, the one or more notches on the inside of the tailgate 140 may restrict movement on a component of the bike 440 positioned inside the truck bed 120.

In one embodiment, the first side panel 420 of the bike interface 400 may include a tailgate lock 450 that is configured to clip to the underside 452 of the tailgate 140. The underside 452 of the tailgate 140 refers to the portion of the tailgate 140 opposite to the top surface 234. As illustrated, the tailgate lock 450 is curved to conform to the curve of the underside 452 of the tailgate 140. However, it should be understood that any suitable mechanism to secure the first side panel 420 to the tailgate 140 may be employed.

Although the illustrated bike interface 400 includes two structures (e.g., base 410 and the first side panel 420), it should be understood that the bike interface may include any additional or alternative sides. For example, the bike interface 400 may include a second side panel that is substantially perpendicular to the base 410 and substantially parallel to the first side panel 420. In one embodiment, the second side panel of the bike interface 400 is positioned on the internal side of the tailgate 140, whereas the first side panel 420 is positioned on the external side of the tailgate 140. In this manner, the base 410 of the of the bike interface 400 may protect the top surface 234 of the tailgate 140 from the bike 410 (e.g., from the tire of the bike 440 directly contacting the tailgate 140); the first side panel 420 of the of the bike interface 400 may protect the external side of the tailgate 140 from the bike (e.g., from the tire of the bike 440 directly contacting the tailgate 140); the second side panel of the of the bike interface 400 may protect the internal side of the tailgate 140 from the bike (e.g., from the tire of the bike 440 directly contacting the tailgate 140).

To remove the bike interface 400 from the tailgate, the locking features of the bike interface 400 may be disengaged from the tailgate 140 (or other component of the vehicle 110). For example, the locking mechanism 220 is positioned under the base 410 of the bike interface 400 and the tailgate lock 450 is positioned on the bottom edge of the first side panel 420. In this example, to remove the bike interface 400 from the tailgate 140, the locking mechanism 220 is disengaged from the accessory locking mechanism 230 on the top surface 234 of the tailgate 140 and the tailgate lock 450 is disengaged from the underside 452 of the tailgate 140. After the bike interface 400 is decoupled from the vehicle 110, the bike interface 400 may be stored (e.g., in the gear tunnel 150) and/or replaced by any other interchangeable member 200.

Turning now to FIGS. 5A and 5B (collectively referred to as “FIG. 5”), which are discussed together, FIG. 5A is a schematic diagram of an exploded view of an example vehicle 110 having an interchangeable member 200, comprising a ski interface 500, coupled to a tailgate 140 of the vehicle 110, in accordance with aspects of the technology described herein. In contrast, FIG. 5B depicts the vehicle 110 of FIG. 5A in an assembled configuration, instead of in an exploded configuration. By way of example, the ski interface 500 may replace the bike interface 400 (of FIG. 4) or any other interchangeable member 200 coupled from a component of the vehicle 110. In some embodiments, the ski interface 500 is coupled to the tailgate 140 via corresponding locking mechanisms. For example, a locking mechanism 220 of the ski interface 500 engages with the accessory locking mechanism 230 of the tailgate 140 (or other vehicle components, such as the left truck bed edge 216 and the right truck bed edge 218).

In one embodiment, the ski interface 500 includes a ski attachment base 510 substantially parallel to the top surface 234 of the tailgate 140. The ski attachment base 510 of the ski interface 500 may serve as a protective cover having a locking mechanism 220 that couples to an accessory locking mechanism 230 of a vehicle component. For example, the ski attachment base 510 couples to a corresponding accessory locking mechanism 230 and covers the top surface 234 of the tailgate 140, the left truck bed edge 216, and/or right truck bed edge 218 of the truck bed 120, as illustrated in FIG. 5B. In this manner, the ski attachment base 510 can couple to any portion of the vehicle 110 to receive and temporarily couple skis to the vehicle 110.

In the illustrated embodiment, the ski attachment base 510 includes a plurality of notches 520. As illustrated in FIG. 5, the notches 520 may be sized to accommodate and receive one or more skis 530. The notches 520 may vary in size, such that the notches 430 (FIG. 4) may accommodate tires of various sizes. When one or more skis 530 are positioned within a notch 520, the notch 520 may restrict movement of the skis 530, for example, along the lateral axis 14. In one example, the ski interface 500 includes additional securing mechanisms, such as a strap, to further restrict movement of the skis 530. For example, a strap may be tied around the ski 530 to further secure the ski 530 to the notch 520 to prevent movement along the longitudinal axis 12, the lateral axis 14, or the vertical axis 16. In this manner, the ski interface 500 facilitates securing, storing, and transporting the ski. For example, the vehicle management client 112 may no longer have to be concerned about the skis 530 sliding along the body of the vehicle 110 while the vehicle management client 112 is putting on their ski boots. Instead, the ski interface 500 provides for improved securement of the skis 530 to the vehicle 110.

Although the illustrated ski interface 500 includes one member (e.g., the ski attachment base 510), it should be understood that the ski interface 500 may include any additional or alternative members. For example, the ski interface 500 may be an assembly that includes the ski attachment base 510 as well as other removable or fixed features. In one embodiment, the underside of the ski interface 500 includes the locking mechanism 220 that is engageable with the accessory locking mechanism 230.

To remove the ski interface 500 from the tailgate 140, the locking mechanism 220 of the ski interface 500 may be disengaged from the accessory locking mechanism 230 of the tailgate 140 (or other component of the vehicle 110). For example, the locking mechanism 220 is positioned under the ski attachment base 510 of the ski interface 500 and the accessory locking mechanism 230 is positioned on the top surface 234 of the tailgate 140, the left truck bed edge 216, and/or the right truck bed edge 218. In this example, to remove the ski interfaces 500 from each of the three vehicle components, the locking mechanism 220 of the ski interface 500 is disengaged from an accessory locking mechanism 230 of the corresponding vehicle component (e.g., the top surface 234 of the tailgate 140, the left truck bed edge 216, and/or the right truck bed edge 218). After the ski interface 500 is decoupled from the vehicle 110, the ski interface 500 may be stored (e.g., in the gear tunnel 150) and/or replaced by any other interchangeable member 200.

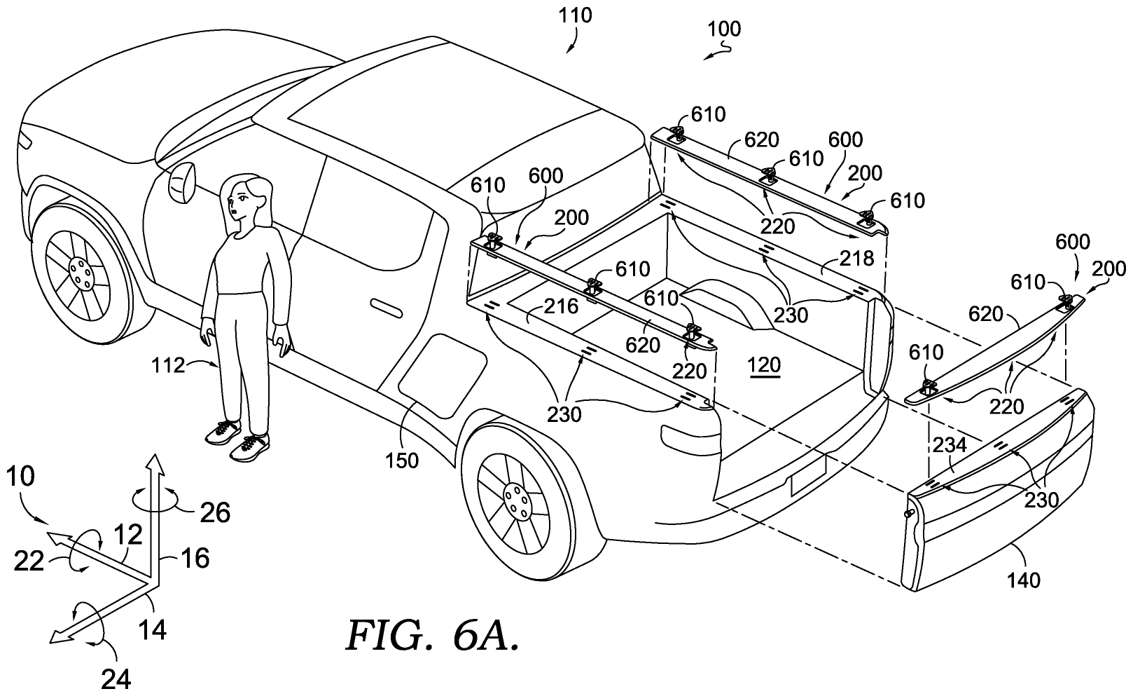

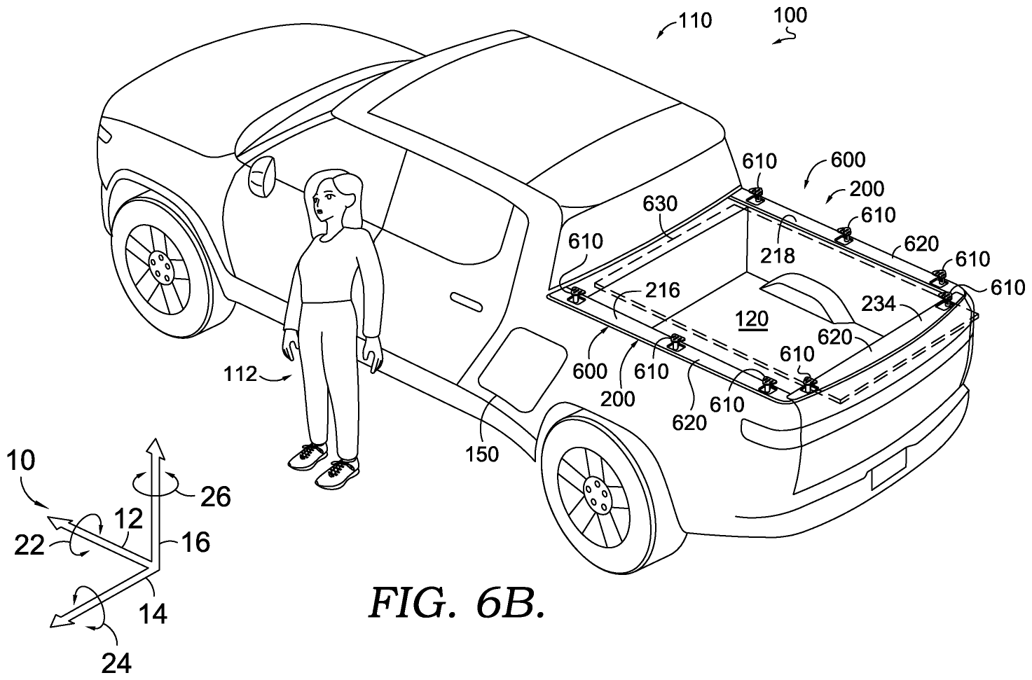

Turning now to FIGS. 6A and 6B (collectively referred to herein as “FIG. 6”), which are discussed together, FIG. 6A is a schematic diagram of an exploded view of an example vehicle 110 having an interchangeable member 200, comprising a clamping interface 600, coupled to a tailgate 140 of the vehicle 110, in accordance with aspects of the technology described herein. On the other hand, FIG. 6B depicts the vehicle 110 of FIG. 6A in an assembled configuration, instead of in an exploded configuration. By way of example, the clamping interface 600 may replace the bike interface 400 (of FIG. 4), the ski interface 500 (of FIG. 5), or any other interchangeable member 200 coupled from a component of the vehicle 110. In some embodiments, the clamping interface 600 is coupled to the tailgate 140 via corresponding locking mechanisms. For example, a locking mechanism 220 of the clamping interface 600 engages with the accessory locking mechanism 230 of the tailgate 140 (or other vehicle components, such as the left truck bed edge 216 and/or the right truck bed edge 218).

In one embodiment, the clamping interface 600 includes at least one clamp 610 that extends out of a base member 620 of the clamping interface 600. The clamp 610 of the clamping interface 600 may serve as a fastener having an adjustable height (e.g., along the vertical axis 16). The height of the clamp 610 may vary to accommodate and fix substantially planar objects (e.g., the wood 630 of FIG. 6B) to the vehicle 110. The base member 620 of the clamping interface 600 may serve as a protective cover having a locking mechanism 220 (e.g., on the underside) that couples to an accessory locking mechanism 230 of a vehicle component. For example, the base member 620 couples to a corresponding accessory locking mechanism 230 and covers the top surface 234 of the tailgate 140, the left truck bed edge 216, and/or right truck bed edge 218 of the truck bed 120, as illustrated in FIG. 6. In this manner, the base member 620 can couple to any portion of the vehicle 110 to receive and temporarily couple objects (e.g., wood 630) to the vehicle 110.

In one embodiment, the clamp 610 is extendable out of the base member 620 to any number of height positions (e.g., along the vertical axis 16). In one embodiment, the clamp 610 is retractable into the base member 620, for example, to be coplanar with the top surface of the base member 620. In embodiments having a plurality of clamps 610, each clamp 610 may move (e.g., extend or retract) independently of other clamps 610. In one example, the clamps 610 of the clamping interface 600 may move together.

To facilitate movement, the clamps 610 may include a ratcheting mechanism that is engageable to adjust a height of the clamp 610 between a recessed position coplanar with the base member 620 and an extended position raised relative to the base member 620 of the clamping interface 600 to a maximum height. In one embodiment, the ratcheting mechanism may include a plurality of alignment mechanism defining predefined heights along the vertical axis to which the clamp 610 may be set. In one embodiment, the ratcheting mechanism may be pushed or engaged to decouple the ratcheting mechanism from the alignment mechanism to change a height of the clamp 610. The ratcheting mechanism may be hidden from the clamping interface 600 to not adversely impact the esthetics of the interchangeable member 200. Although the height of the clamp 610 is discussed in the concept of a ratcheting mechanism, any suitable mechanical, electric, or electromechanical system for achieving variable heights may be employed. Additionally or alternatively, any suitable system capable of displacing the clamps 610 along any suitable direction (e.g., illustrated in coordinate system 10) may be employed.

Although the illustrated clamping interface 600 includes one base member, it should be understood that the clamping interface 600 may include any additional or alternative members. For example, the clamping interface 600 may be an assembly that includes the base member 620, as well as other removable or fixed features. In one embodiment, the clamping interface 600 may include a truck bed cover that covers the entire or a portion of the truck bed 120, thereby forming an enclosed or partially enclosed cavity of the truck bed 120.

To remove the clamping interface 600 from the tailgate 140, the locking mechanism 220 of the clamping interface 600 may be disengaged from the accessory locking mechanism 230 of the tailgate 140 (or other component of the vehicle 110). For example, the locking mechanism 220 is positioned under the base member 620 of the clamping interface 600 and the accessory locking mechanism 230 is positioned on the top surface 234 of the tailgate 140, the left truck bed edge 216, and/or the right truck bed edge 218. In this example, to remove the clamping interface 600 from each of the three vehicle components, the locking mechanism 220 of the clamping interface 600 is disengaged from an accessory locking mechanism 230 of the corresponding vehicle component (e.g., the top surface 234 of the tailgate 140, the left truck bed edge 216, and/or the right truck bed edge 218). After the clamping interface 600 is decoupled from the vehicle 110, the clamping interface 600 may be stored (e.g., in the gear tunnel 150) and/or replaced by any other interchangeable member 200.

Turning to FIG. 7A, depicted is a schematic diagram of an example vehicle 110 having an interchangeable member 200 of a plurality of interchangeable members 200 coupled to a window sill 700 of the vehicle 110, in accordance with aspects of the technology described herein. Whereas the previously illustrated embodiments include a vehicle 110 that is a truck, the illustrated embodiment includes a vehicle that is a sport utility vehicle (SUV). As illustrated, example interchangeable members 200, such as the bike interface 400 (FIG. 4), the ski interface (FIG. 5), and the clamping interface 600 (FIG. 6), can be interchanged and selectively coupled to the window sill 700. In one example, the window sill 700 includes a slit into and out of which a window is configured to transition between an open state and a closed state. In one example, the window sill 700 includes a first surface interior to the vehicle and a second surface exterior to the vehicle, such that the other locking mechanism is positioned on at least one of the first surface or the second surface.

In one example, to couple the interchangeable member 200 to the window sill 700, the window of the vehicle 110 may be lowered to expose the window sill; thereafter, the interchangeable member can couple to the window will via respective locking mechanisms. For example, the locking mechanism 220 (FIGS. 2 and 3) of the interchangeable member 200 may couple to an accessory locking mechanism on a vehicle component on the body 114 of the vehicle 110. Although in FIG. 7A the interchangeable member 200 is illustrated as being coupled to a rear window sill 710 on the rear door 712, it should be understood that the interchangeable member 200 may also or alternatively be couple to another vehicle component, such as any other window sill (e.g., the window sills on the left side 126 or the right side 128 of the vehicle 110). Additionally or alternatively, in one embodiment, the interchangeable member 200 is coupled to the outward face of the rear door. For example, when the rear door 712 is open (as shown in FIG. 7B) and the window is open, the interchangeable member 200 can couple to the outward face of the rear door 712 proximate to the rear window sill 710. In this example, the outward face of the rear door 712 proximate to the rear window sill 710 includes an accessory locking mechanism 230.

Turning to FIG. 7B, depicted is a schematic diagram of an example vehicle 110 having an interchangeable member 200 of a plurality of interchangeable members 200 coupled to a rear cargo guard 720 of the vehicle 110, in accordance with aspects of the technology described herein. In this example, the vehicle component includes a rear cargo guard 720 that is an elevated guard preventing cargo inside the vehicle 110 from falling out when the rear door 712 is opened. In one embodiment, the top of the rear cargo guard 720 is elevated from the floor of the vehicle storage space by a distance 722. The rear cargo guard 720 may be positioned inside the vehicle 110 and exposed when the rear door 712 opens. In one example, the rear door 712 opens by hinging along the roof of the vehicle about the lateral axis 14 along pitch direction 24. When the rear cargo guard 720 is exposed, any of the interchangeable members may couple or decouple from the rear cargo guard 720.

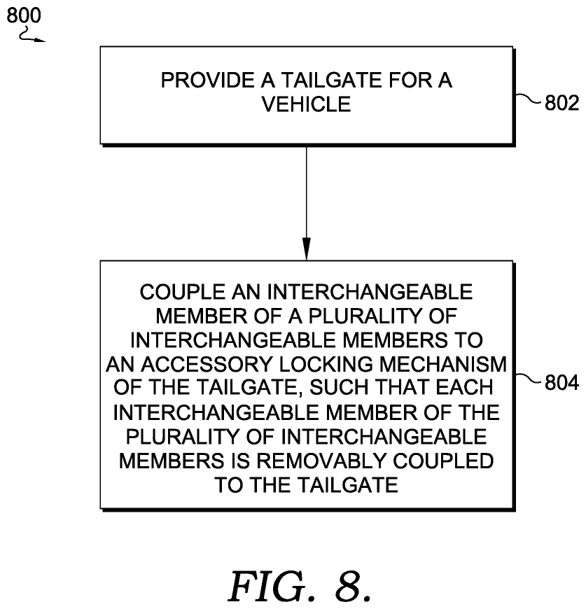

FIG. 8 is a flow diagram of an example process 800 for providing an interchangeable member 200 (FIG. 2) to a vehicle 110 (FIGS. 1 and 7), in accordance with aspects of the technology described herein. It should be understood that process 800 may be performed by any suitable device or person. Additionally, any steps in process 800 may be omitted and/or other steps added. At block 802, example process 800 includes providing a vehicle component, such as a tailgate 140 (FIG. 1) for a vehicle 110.

At block 804, example process 800 includes coupling the interchangeable member 200 of a plurality of interchangeable members 200 to an accessory locking mechanism 230 (FIG. 2) of the vehicle component, such as the tailgate. In one embodiment, each interchangeable member 200 of the plurality of members 200 is coupled to the tailgate 140. In one example, coupling (block 804) the interchangeable member includes coupling a locking mechanism 220 (FIG. 2) of the interchangeable member 200 to the accessory locking mechanism 230 positioned on a top surface 234 (FIG. 2) of the tailgate 140 of the vehicle 110. The interchangeable member may be coupled between a body in white (BiW) of the vehicle component (e.g., tailgate 140) and a trim of the vehicle component (e.g., tailgate 140).

Example process 800 may include any additional or alternative steps, in addition to or in lieu of those illustrated in process 800. For example, process 800 may include decoupling the interchangeable member 200 from the vehicle component (e.g., tailgate 140). Additionally or alternatively, example process 800 may include coupling another interchangeable member of the plurality of interchangeable members to vehicle component (e.g., tailgate 140) to replacing the interchangeable member with the other interchangeable member.

### Additional Support for Detailed Description of the Disclosed Subject Matter

### Example Electric Vehicle System

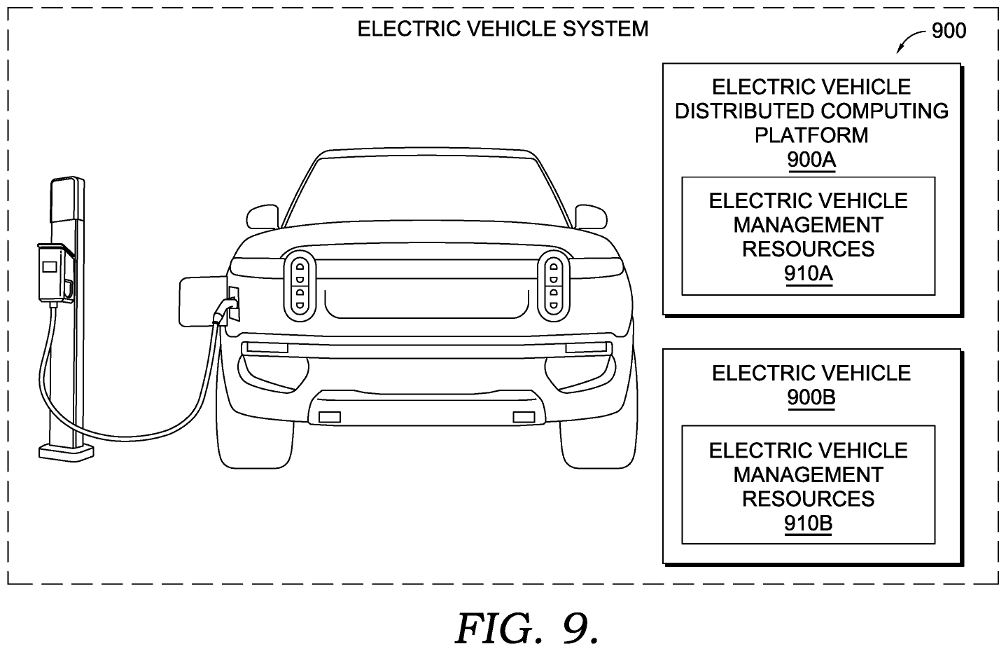

With reference to FIG. 9, FIG. 9 illustrates an example electric vehicle system 900 in which implementations of the present disclosure may be employed. In particular, FIG. 9 shows a high level architecture of an example electric vehicle distributed computing platform 900A and electric vehicle 900B having electric vehicle management resources 910A and electric vehicle management resources 910B, respectively, that support the functionality described herein. The electric vehicle system 900 can host a technical solution environment, or a portion thereof.

The electric vehicle distributed computing platform 900A includes electric vehicle management resources 910A that provide and support electric vehicle distributed computing systems and operations. Electric vehicle distributed computing platform 900A can run cloud services across different data centers and geographic regions. Typically, the electric vehicle distributed computing platform 900A acts to store data or run service applications in a distributed manner. For example, a service application can be supported by a computing environment (e.g., host, node, and virtual machine) and resources (e.g., hardware resources and software resources) that can configure the service application; and a client device may be linked to a service application and configured to issue commands to the service application. Communications in the electric vehicle distributed computing platform 900A are performed through a virtual Internet Protocol (IP) and over a network (not shown), which may include, without limitation, one or more local area networks (LANs) and/or wide area networks (WANs).

The electric vehicle 900B includes electric vehicle management resources 910B that provide and support electric vehicle systems and operations. Electric vehicle 900B can refer to a vehicle that uses electric power. The electric vehicle 900B can be built on a configuration for an automotive chassis used for automotive platforms of battery electric vehicles. The configuration can include a base structure that houses the batteries, electric motors, and other electronic components of the electric vehicle, such as those described herein. By way of example, the electric vehicle can include a steering system, brake sensor system, and controller systems.

Controllers can include one or more systems on chips (SoCs) that may provide signals to one or more components and systems of the vehicle. For example, controllers can support a steering system, braking system, one or more onboard computing devices, artificial intelligence functionality (e.g., computer vision), infotainment functionality, global navigation satellite systems and sensors (e.g., Global Positioning System sensors, RADAR sensors, LIDAR sensors) and inertial measurement unit (IMU) sensors (e.g., accelerometers, gyroscopes). Controllers may receive inputs (e.g., represented by input data) from and provide outputs (e.g., represented by output data, display data, etc.) via a human-machine interface (HMI) display and other components of the electric vehicle.

The electric vehicle further includes a network interface which may use one or more wireless antenna(s) and/or modem(s) to communicate over one or more networks. For example, the network interface may be capable of communication over LTE, WCDMA, UMTS, GSM, CDMA2000, etc. The wireless antenna(s) may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown. The various blocks are shown with lines for the sake of conceptual clarity, and other arrangements of the described components and/or component functionality are also contemplated. FIG. 9 is merely meant to be illustrative of an example electric vehicle and electric vehicle system that can be used in connection with one or more embodiments of the present disclosure.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a orb, as well as a and b). Additionally, the term “substantially” includes a degree of correlation or similarity between elements, and may include a deviation of less than 20%, 10%, 5%, 1%, or any other unit.

For purposes of a detailed discussion above, embodiments of the present disclosure are described with reference to a distributed computing environment; however, the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present disclosure may generally refer to the technical solution environment and the schematics described herein, it is understood that the techniques described may be extended to other implementation contexts.

Embodiments of the present disclosure have been described in relation to particular embodiments which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. An apparatus, comprising:
a locking mechanism of a tailgate configured to lock an interchangeable member to the tailgate, wherein the locking mechanism is further configured to unlock the interchangeable member from the tailgate.

2. The apparatus of claim 1, wherein the interchangeable member comprises a bike interface.

3. The apparatus of claim 2, wherein the bike interface comprises a base coupled to a surface of the tailgate and a first side panel substantially perpendicular to the surface of the tailgate.

4. The apparatus of claim 3, wherein at least one of the base or the first side panel of the bike interface comprises at least one notch configured to at least partially secure a bike.

5. The apparatus of claim 1, wherein the interchangeable member comprises a ski interface comprising at least one notch configure to at least partially secure a ski.

6. The apparatus of claim 1, wherein the interchangeable member comprises a clamping interface comprising at least one clamp that is extendable from the interchangeable member or that is retractable into the interchangeable member.

7. The tailgate of claim 1, wherein the interchangeable member comprises a clamping interface comprising:
a first clamp positioned on a first end of the interchangeable member; and
a second clamp positioned on a second end of the interchangeable member.

8. The apparatus of claim 1, wherein the interchangeable member comprises a clamping interface that comprises a ratcheting mechanism that is engageable to adjust a height of at least one clamp between a recessed position coplanar with the interchangeable member and an extended position raised relative to the interchangeable member.

9. The apparatus of claim 1, wherein the locking mechanism is positioned on a surface and is configured to engage with a corresponding locking mechanism of the interchangeable member.

10. The apparatus of claim 9, wherein the locking mechanism of the tailgate comprises a plurality of openings and the corresponding locking mechanism of the interchangeable member comprises a plurality of locking clips configured to clip into the plurality of openings.

11. A vehicle, comprising:
a body; and
a vehicle component coupled to the body and comprising a locking mechanism to selectively lock to an interchangeable member.

12. The vehicle of claim 11, wherein the vehicle component comprises a window sill that comprises the locking mechanism to selectively lock to the interchangeable member, wherein the window sill is positioned on a rear side of the vehicle and comprises a first surface interior to the vehicle and a second surface exterior to the vehicle, wherein a corresponding locking mechanism of the interchangeable member is engageable with the locking mechanism and is positioned on at least one of the first surface or the second surface.

13. The vehicle of claim 11, wherein the vehicle component comprises at least one of: a window sill, a tailgate of a truck, a tailgate of an SUV, a top of a cabin of the vehicle, or a side of a bed of the truck.

14. The vehicle of claim 11, wherein the locking mechanism is positioned on a surface of the vehicle component and is configured to engage with a corresponding locking mechanism of the interchangeable member.

15. The vehicle of claim 11, wherein the interchangeable member comprises at least one of: a bike interface, a ski interface, or a clamping interface.

16. The vehicle of claim 15, wherein the bike interface comprises a base parallel to a top surface of the vehicle component and a first side panel substantially perpendicular to the top surface of the vehicle component, wherein at least one of the base or the first side panel of the bike interface comprises at least one notch configured to at least partially secure a bike, wherein the ski interface comprises at least one notch configure to at least partially secure a ski, and wherein the clamping interface comprise a plurality of clamps extendable out of the interchangeable member to a plurality of heights or are retractable into the interchangeable member.

17. A method, comprising:
coupling an interchangeable member to a locking mechanism configured to uncouple the interchangeable member from a tailgate.

18. The method of claim 17, wherein coupling the interchangeable member comprises coupling a corresponding locking mechanism of the interchangeable member to the locking mechanism positioned on a top surface of the tailgate of a vehicle.

19. The method of claim 17, further comprising:
decoupling the interchangeable member from the tailgate; and
coupling another interchangeable member of a plurality of interchangeable members to the tailgate to replace the interchangeable member with the other interchangeable member.

20. The method of claim 17, wherein the interchangeable member is coupled between a body in white (BiW) of the tailgate and a trim of the tailgate.
